(19) United States
(12) Patent Application Publication
(10) Pub. No.: US 2007/0033062 A1
(43) Pub. Date: Feb. 8, 2007

(54) Business methods, systems, and computer programs for designing customized biological assays and producing related catalogs and kits

(75) Inventor: Todd M. Hauser, Seattle, WA (US)

Correspondence Address: SEED INTELLECTUAL PROPERTY LAW GROUP PLLC, 701 FIFTH AVE, SUITE 5400, SEATTLE, WA, 98104, US

(73) Assignee: OligoEngine, Inc., Seattle, WA (US)

(21) Appl. No.: 11/414,537

(22) Filed: Apr. 28, 2006

Related U.S. Application Data
(60) Provisional application No. 60/676,622, filed on Apr. 28, 2005.

(51) Int. Cl. G06Q 99/00

(52) U.S. Cl. 705/1

(57) ABSTRACT

The present invention provides business methods, systems, and computer programs for identifying, categorizing, and guiding the selection of biological assays and reagents, as well as producing and selling customized catalogs and kits of reagents that may be used in performing such assays. These business methods, systems, and computer programs may be directed to a variety of applications, including biological research, medical diagnostics and therapeutics, detection or identification of microorganisms, contaminants, or infectious agents, and measuring or monitoring gene expression.

### CROSS-REFERENCE TO RELATED APPLICATION

This application claims the benefit under 35 U.S.C. § 119(e) of U.S. Provisional Patent Application No. 60/676,622 filed on Apr. 28, 2005, which provisional application is incorporated herein by reference in its entirety.

### BACKGROUND OF THE INVENTION

1. Field of the Invention

The present invention is directed to business methods, systems, and computer programs for identifying, categorizing, and guiding the selection of biological assays and reagents, as well as producing and selling customized catalogs and kits of reagents that may be used in performing such assays.

2. Description of the Related Art

In recent years, a variety of techniques have been developed to measure or alter gene expression, based upon nucleic acid modification or hybridization. For example, the development of the polymerase chain reaction (PCR) revolutionized methods related to measuring the amount of a particular target DNA or RNA in a sample, and gene expression knockdown methods, such as antisense RNA, postranscriptional gene silencing (PTGS), and RNA interference (RNAi), with both research and therapeutic applications, have greatly enhanced the ability to regulate gene expression. These and related methods may be used in a variety of applications, including diagnostic methods based upon identifying gene mutations associated with disease or determining gene over- or under-expression associated with disease, as well as basic research on gene function and therapeutic treatment of diseases associated with gene mutation or aberrant expression.

Antisense strategies for gene silencing have attracted much attention in recent years. The underlying concept is simple yet (in principle) effective: antisense nucleic acids (NA) base pair with a target RNA resulting in inactivation. Target RNA recognition by antisense RNA or DNA can be considered a hybridization reaction. Since the target is bound through sequence complementarity, this implies that an appropriate choice of antisense NA should ensure high specificity. Inactivation of the targeted RNA can occur via different pathways, dependent on the nature of the antisense NA (either modified or unmodified DNA or RNA) and on the properties of the biological system in which inhibition is to occur.

RNAi or double-stranded RNA-mediated suppression of gene expression has been established in a variety of cell types, including mammalian cells. Indeed, the direct introduction of short interfering RNAs (siRNAs) to a cell can trigger RNAi in mammalian cells (Elshabir, S. M., et al., Nature 411:494-498 (2001)). Suppression in mammalian cells occurs at the RNA level and is specific for the targeted genes, with a strong correlation between RNA and protein suppression (Caplen, N. et al., Proc. Natl. Acad. Sci. USA 98:9746-9747 (2001)).

While all of these techniques show great promise in determining or altering gene expression levels, the selection of the optimal method for any particular purpose, the best target sequences within a gene, as well as the optimal composition of PCR primers or knockdown reagents remains problematic. Results using specific target sequences and reagents have proven highly variable and unpredictable, and non-specific effects of particular reagents can limit their usefulness in certain applications. The best method or reagent to use in determining or altering gene expression levels varies, depending upon the particular assay or cellular environment. Accordingly, there remains a need in the art for novel methods, systems, and computer programs for identifying, categorizing, and guiding the selection of particular biological assays and reagents, depending upon the desired biological result and environment, as well as business methods for producing and selling customized catalogs and kits of reagents that may be used in performing selected biological assays.

### BRIEF SUMMARY OF THE INVENTION

The present invention provides business methods, systems and computer programs useful for identifying, categorizing, and guiding the selection of biological assays and reagents, as well as producing and selling customized catalogs and kits of reagents that may be used in performing such assays.

In one embodiments, the present invention provides a method for producing a customized sales catalog of products, that includes: receiving information regarding a biological assay from a customer, wherein said information includes the identification of a target polynucleotide sequence and a desired result; one or more biological assays to achieve said desired result, wherein said designing includes identifying one or more reagents comprising a polynucleotide sequence that may be used is said biological assay; and generating a sales catalog comprising an identified reagent, thereby producing a customized sales catalog. In particular embodiments, a plurality of biological assays and/or reagents are identified and categorized, based upon one or more predicted biological effects. In further related embodiments, said sales catalog or related documentation further includes protocols for performing the biological assays

In particular embodiments of the invention, the methods are performed using a computer device comprising: a first knowledge base comprising a plurality of different biological assays; and a second knowledge base comprising a plurality of rules for evaluating and selecting a biological assay based upon information regarding the target polynucleotide sequence and desired result or outcome.

In a related embodiment, the present invention includes a business method for selling customized biological assay kits, comprising: receiving information regarding a biological assay from a customer, wherein said information includes the identification of a target polynucleotide sequence and a desired result; designing one or more biological assays to achieve said desired result, wherein said designing includes identifying one or more reagents comprising a polynucleotide sequence that may be used is said biological assay; and selling to the customer a kit comprising one or more of the identified reagents. In a particular embodiment, the business method also includes generating a sales catalog comprising one or more kits comprising identified reagents and providing said catalog to the customer.

In certain embodiments, one or more steps of the business method are performed using a computer device comprising: a first knowledge base comprising a plurality of different biological assays; and a second knowledge base comprising a plurality of rules for evaluating and selecting a biological assay based upon inputted information.

In an additional embodiment, the present invention provides a method for guiding the selection of a therapeutic reagent for treating a disease or medical disorder, comprising: receiving information regarding a gene that is mutated or overexpressed in a disease or medical disorder; identifying one or more reagents comprising a polynucleotide sequence that may be used to reduce expression of the mutated or overexpressed gene; categorizing the identified reagents based upon one or more predicted biological effects; and providing documentation related to the categorization to a medical professional, to assist in guiding the selection of a therapeutic reagent for treating the disease or medical disorder. In a particular embodiment, said biological effects include binding specificity.

In further related embodiments, one or more steps of the method of guiding selection of a therapeutic agent is performed using a computer device comprising: a first knowledge base comprising a plurality of different biological assays and/or reagents; and a second knowledge base comprising a plurality of rules for evaluating and selecting a biological assay and/or reagent based upon inputted information.

The present invention, in an additional embodiment, includes a business method for selling a therapeutic reagent to treat a disease or medical disorder associated with a gene mutation or gene overexpression, comprising: receiving information regarding a gene that is mutated or overexpressed in a disease or medical disorder; identifying one or more reagents comprising a polynucleotide sequence that may be used to reduce expression of the mutated or overexpressed gene; and selling an identified reagent to a medical professional or patient for treatment of the disease or medical disorder.

Particular embodiments of this business method further include: categorizing the identified reagents based upon one or more predicted biological effects; and providing information regarding the categorization to a medical professional, to assist in guiding the selection of a therapeutic reagent for treating the disease or medical disorder.

In additional related embodiments, one or more steps of these methods are performed using a computer device comprising: a knowledge base comprising a plurality of different biological assays and/or reagents; and a second knowledge base comprising a plurality of rules for evaluating and selecting a biological assay and/or reagent based upon inputted or received information.

In a further embodiment, the present invention includes a system for guiding the selection of a biological assay or reagent to achieve a desired result, comprising: a computing device comprising: a first knowledge base comprising a plurality of different biological assays and/or reagents; and a second knowledge base comprising a plurality of rules for evaluating and selecting a biological assay and/or reagent based upon the desired result; means for providing information regarding a target polynucleotide sequence and a desired result to said computing device; and means in said computing device for identifying and categorizing or ranking one or more biological assays and/or reagents comprising a polynucleotide sequence that may be used to reduce expression of said target polynucleotide sequence.

The present invention also includes, in a related embodiment, a computer program product for guiding the selection of a biological assay or reagent to achieve a desired result, said computer program product comprising a computer usable storage medium having computer readable program code means embodies in the medium, the computer readable program code means comprising: computer readable program code means for generating: a first knowledge base comprising a plurality of different biological assays and/or reagents; and a second knowledge base comprising a plurality of rules for evaluating and selecting a biological assay and/or reagent based upon the desired result; computer readable program code means for providing information regarding a target polynucleotide sequence and a desired result to said computing device; and computer readable program code means for identifying and categorizing or ranking one or more biological assays and/or reagents comprising a polynucleotide sequence that may be used to reduce expression of said target polynucleotide sequence.

### BRIEF DESCRIPTION OF THE DRAWING

FIG. 1 provides a flow diagram outlining one embodiment of the present invention directed to identifying and categorizing biological assays based upon customer input, and providing related documentation and customized catalogs and kits of reagents used to perform identified biological assays.

### DETAILED DESCRIPTION OF THE INVENTION

The present invention provides novel methods and systems for biological assay planning, as well as related business methods for guiding the selection of particular biological methods and reagents, producing a customized catalog of reagents based upon customer input, and selling reagents and kits for performing selected biological assays. Thus, in particular embodiments, the present invention provides a novel method of scientific planning by creating a custom and real-time document predicting, planning, justifying, and cataloging biological reagents and protocols utilized in a field of study or biological assay or designed to achieve a desired biological result.

In general, the methods and systems of the invention involve receiving information from a user or customer regarding a desired outcome and target polynucleotide sequence, and identifying one or more biological assays and/or reagents that may be used to achieve the desired outcome. In preferred embodiments, identified biological assays and/or reagents are categorized and/or ranked, based upon their predicted biological effects. The identified biological assays and associated categorization or ranking information may be provided to a user or customer, to assist in selecting a biological assay or reagent, or as a sales catalog, which further includes kits of reagents that may be used to perform the biological assays, as well as protocols for performing the biological assays. As such, the methods and systems of the invention may be used to generate a customized catalog of biological reagents that may be purchased by a customer to perform one or selected biological assays.

In addition to identifying biological assays and reagents selected to achieve the desired result, the methods and systems of the present invention may further include identifying additional biological assays to be used in concert with the selected assay, for example, to confirm that the selected biological assay is achieving the desired result, as well as additional reagents, for example, negative control reagents, which should not achieve the same result as the initially selected reagent.

The methods and systems of the present invention are particularly well suited to biological assays involving measuring gene expression, detecting gene mutations, or altering gene expression. As such, in preferred embodiments, the methods and systems of the present invention are based upon a user or customer selecting a target polynucleotide sequence for detection or for altered expression, and selected reagents will comprise a polynucleotide sequence.

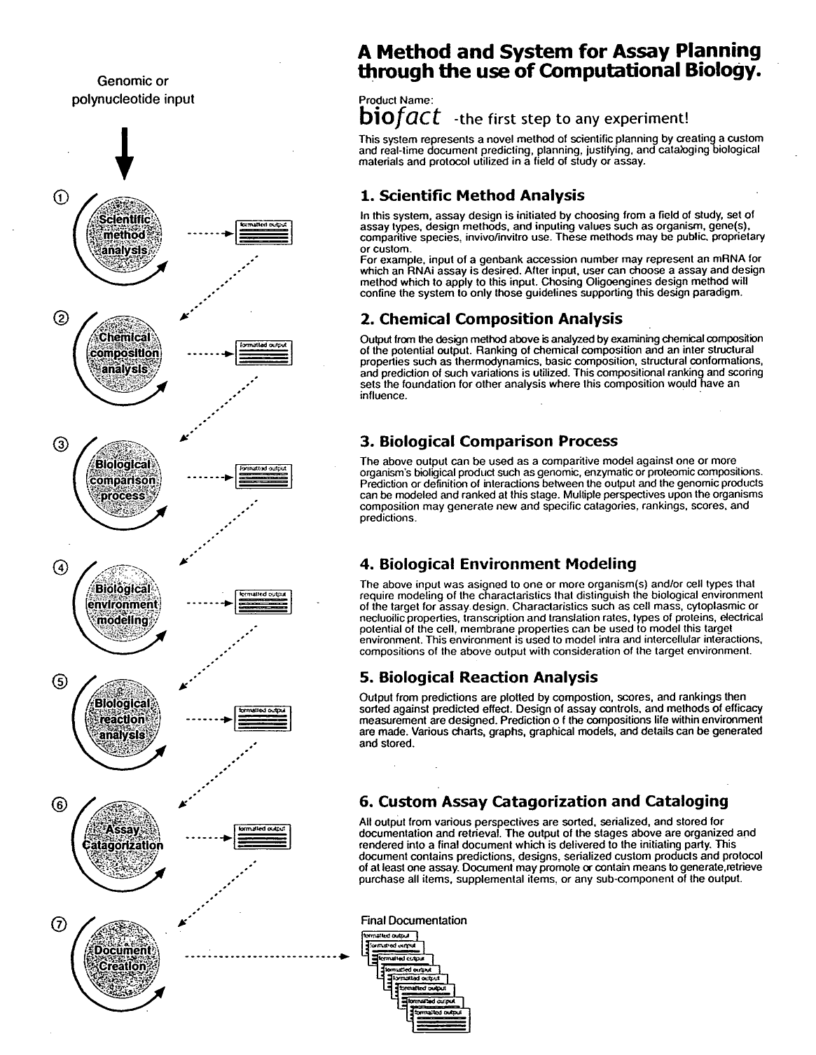

As illustrated in FIG. 1, the methods and systems of the present invention may include any or all of a number of steps, including but not limited to: scientific methods analysis, chemical composition analysis, biological comparison process, biological environment modeling, biological reaction analysis, assay categorization, cataloging, and document creation.

In particular embodiments, scientific method analysis involves selecting one or more biological assays to achieve a desired outcome, based upon user or customer input. Desired outcomes may include, but are not limited to, determining the level of expression of a particular target gene, determining the presence or absence of a gene mutation, or reducing the expression of a particular target gene. Examples of biological assays utilized according to the present invention to determine the level of expression of a particular target gene or determine the presence or absence of a gene mutation include, but are not limited to, PCR, primer extension, S1 analysis, nuclear run-off, rolling circle amplification, and other primer-based DNA amplification methods. Examples of biological assays to reduce gene expression include, but are not limited to, antisense RNA, PTGS, RNAi, and DNA methylation. Biological assays may be public, proprietary, or custom.

The selection of appropriate biological assays may take into account any of a variety of different information provided by the user or customer, including, but not limited to the field of study, desired assay types, specific design methods, as well as the organism, cell type, or assay condition, e.g., in vitro or in vivo. Assays are selected based upon the information provided, as well as knowledge in the art regarding the appropriateness and effectiveness of particular assays and reagents for the selected conditions.

The target gene or polynucleotide sequence may be identified or inputted into the system via any format, including, for example, using the gene name, its polynucleotide sequence, or a genbank accession number.

Assay design typically includes the selection of one or more reagents that may be used to perform said assay. Reagents of the present invention generally comprise a polynucleotide sequence corresponding to one or more regions of a target gene, or a complement thereof. In general, methods of selecting a particular polynucleotide sequence to include are known and available in the art.

Reagents of the present invention can include, e.g., genomic sequences, coding sequences, complementary sequences, extra-genomic and plasmid-encoded sequences, and linear or circular polynucleotides. Such polynucleotides may be naturally isolated, or modified synthetically. Reagents of the invention may be include single-stranded (coding or antisense strand) or double-stranded polynucleotides, and may be DNA (genomic, cDNA or synthetic) or RNA molecules. In various embodiments, reagents are antisense RNA, ribozymes, or RNAi reagents designed to specifically inhibit expression of a target gene.

In one embodiment, a reagent is an antisense RNA directed to a target gene. Antisense oligonucleotides have been demonstrated to be effective and targeted inhibitors of protein synthesis, and, consequently, can be used to specifically inhibit protein synthesis by a targeted gene. Examples of antisense inhibition have been demonstrated with the nuclear protein cyclin, the multiple drug resistance gene (MDG1), ICAM-1, E-selectin, STK-1, striatal GABAA receptor and human EGF (Jaskulski et al., Science 240:1544-6 (1988); Vasanthakumar and Ahmed, Cancer Commun. 1:225-32 (1989); Peris et al., Brain Res Mol Brain Res. 57:310-20 (1998); U.S. Pat. No. 5,801,154; U.S. Pat. No. 5,789,573; U.S. Pat. No. 5,718,709 and U.S. Pat. No. 5,610,288). In one embodiment, the antisense oligonucleotides comprise DNA or derivatives thereof. In another embodiment, the oligonucleotides comprise RNA or derivatives thereof. The antisense oligonucleotides may be modified DNAs comprising a phosphorothioated modified backbone. Also, the oligonucleotide sequences may comprise peptide nucleic acids or derivatives thereof. In each case, preferred antisense RNA reagents comprise a sequence region that is complementary, and more preferably, completely complementary to one or more portions of a target gene or polynucleotide sequence.

Methods of producing antisense molecules are known in the art. For example, antisense molecules may be chemically synthesized or expressed from an appropriate vector. Selection of antisense compositions specific for a given sequence is based upon analysis of the chosen target sequence and determination of secondary structure, Tₘ, binding energy, and relative stability. Antisense compositions may be selected based upon their relative inability to form dimers, hairpins, or other secondary structures that would reduce or prohibit specific binding to the target mRNA in a host cell. Highly preferred target regions of the mRNA include those regions at or near the AUG translation initiation codon and those sequences that are substantially complementary to 5′ regions of the mRNA. These secondary structure analyses and target site selection considerations can be performed, for example, using v.4 of the OLIGO primer analysis software and/or the BLASTN 2.0.5 algorithm software (Altschul et al., Nucleic Acids Res. 1997, 25(17):3389-402) or the Advanced RNAi Software and other customization tools provided by OligoEngine, Inc. (Madison, Wis.).

According to another embodiment of the invention, ribozyme molecules are used to inhibit expression of a target gene. Ribozymes are RNA-protein complexes that cleave nucleic acids in a site-specific fashion. Ribozymes have specific catalytic domains that possess endonuclease activity (Kim and Cech, Proc Natl Acad Sci USA 84:8788-92 (1987); Forster and Symons, Cell 49:211-20 (1987)). At least six basic varieties of naturally occurring enzymatic RNAs have been described. Each can catalyze the hydrolysis of RNA phosphodiester bonds in trans (and thus can cleave other RNA molecules) under physiological conditions. In general, enzymatic nucleic acids act by first binding to a target RNA. Such binding occurs through the target-binding portion of an enzymatic nucleic acid, which is held in close proximity to an enzymatic portion of the molecule that acts to cleave the target RNA. Thus, the enzymatic nucleic acid first recognizes and then binds a target RNA through complementary base-pairing, and once bound to the correct site, acts enzymatically to cut the target RNA. Strategic cleavage of such a target RNA will destroy its ability to direct synthesis of an encoded protein. After an enzymatic nucleic acid has bound and cleaved its RNA target, it is released from that RNA to search for another target and can repeatedly bind and cleave new targets.

The enzymatic nature of a ribozyme may be advantageous over many technologies, such as antisense technology (where a nucleic acid molecule simply binds to a nucleic acid target to block its translation), since the concentration of ribozyme necessary to affect inhibition of expression is typically lower than that of an antisense oligonucleotide. This advantage reflects the ability of the ribozyme to act enzymatically. Thus, a single ribozyme molecule is able to cleave many molecules of target RNA. In addition, the ribozyme is a highly specific inhibitor, with the specificity of inhibition depending not only on the base pairing mechanism of binding to the target RNA, but also on the mechanism of target RNA cleavage. Single mismatches, or base-substitutions, near the site of cleavage can completely eliminate catalytic activity of a ribozyme. Similar mismatches in antisense molecules do not prevent their action (Woolf et al., Proc Natl Acad Sci USA 89:7305-9 (1992)). Thus, the specificity of action of a ribozyme is greater than that of an antisense oligonucleotide binding the same RNA site.

The enzymatic nucleic acid molecule may be formed in a hammerhead, hairpin, a hepatitis δ virus, group I intron or RNaseP RNA (in association with an RNA guide sequence) or Neurospora VS RNA motif, for example. Specific examples of hammerhead motifs are described by Rossi et al. Nucleic Acids Res. 20:4559-65 (1992). Examples of hairpin motifs are described by Hampel et al. (Eur. Pat. Appl. Publ. No. EP 0360257), Hampel and Tritz, Biochemistry 28:4929-33 (1989); Hampel et al., Nucleic Acids Res. 25:299-304 (1990) and U.S. Pat. No. 5,631,359. An example of the hepatitis δ virus motif is described by Perrotta and Been, Biochemistry 31:11843-52 (1992); an example of the RNaseP motif is described by Guerrier-Takada et al., Cell 35:849-57 (1983); Neurospora VS RNA ribozyme motif is described by Collins (Saville and Collins, Cell 6:685-96 (1990); Saville and Collins, Proc Natl Acad Sci USA 88:8826-30 (1991); Collins and Olive, Biochemistry 32:2795-9 (1993)); and an example of the Group I intron is described in (U.S. Pat. No. 4,987,071). Important characteristics of enzymatic nucleic acid molecules used according to the invention are that they have a specific substrate binding site which is complementary to one or more of the target gene DNA or RNA regions, and that they have nucleotide sequences within or surrounding that substrate binding site which impart an RNA cleaving activity to the molecule. Thus, the ribozyme constructs need not be limited to specific motifs mentioned herein.

Ribozyme activity can be optimized by altering the length of the ribozyme binding arms or chemically synthesizing ribozymes with modifications that prevent their degradation by serum ribonucleases (see e.g., PCT Publ. No. WO 92/07065; PCT Publ. No. WO 93/15187; PCT Publ. No. WO 91/03162; Eur. Pat. Appl. Publ. No. 92110298.4; U.S. Pat. No. 5,334,711; and PCT Publ. No. WO 94/13688, which describe various chemical modifications that can be made to the sugar moieties of enzymatic RNA molecules), modifications which enhance their efficacy in cells, and removal of stem 11 bases to shorten RNA synthesis times and reduce chemical requirements.

In other embodiments, a reagent is an RNAi molecule. RNAi molecules also may be used to disrupt the expression of a target gene or polynucleotide. While the first described RNAi molecules were RNA:RNA hybrids comprising both an RNA sense and an RNA antisense strand, it has now been demonstrated that DNA sense:RNA antisense hybrids, RNA sense:DNA antisense hybrids, and DNA:DNA hybrids are capable of mediating RNAi (Lamberton, J. S. and Christian, A. T., Molecular Biotechnology 24:111-119 (2003)). Accordingly, the invention includes the use of RNAi reagents comprising any of these different types of double-stranded molecules. In addition, it is understood that RNAi reagents may be used and introduced to cells in a variety of forms. Accordingly, as used herein, RNAi reagents encompasses any and all reagents capable of inducing an RNAi response in cells, including, but not limited to, double-stranded polynucleotides comprising two separate strands, i.e., a sense strand and an antisense strand, polynucleotides comprising a hairpin loop of complementary sequences, which forms a double-stranded region, e.g., shRNAi molecules, and expression vectors that express one or more polynucleotides capable of forming a double-stranded polynucleotide alone or in combination with another polynucleotide. Specific examples of types of reagents that may be used or selected according to the present invention are described in U.S. patent application Ser. Nos. 10/793,425, 10/847,204, and 60/640,584.

RNAi reagents can be readily prepared according to procedures known in the art. Structural characteristics of effective siRNA molecules have been identified. Elshabir, S. M. et al. Nature 411:494-498 (2001) and Elshabir, S. M. et al., EMBO 20:6877-6888 (2001). Accordingly, one of skill in the art would understand that a wide variety of different siRNA molecules may be used to target a specific gene or transcript. In certain embodiments, siRNA molecules according to the invention are 16-30 or 18-25 nucleotides in length, including each integer in between. In certain embodiments, siRNAs have 0-7 nucleotide 3′ overhangs or 0-4 nucleotide 5′ overhangs. In one embodiment, an siRNA molecule has a two nucleotide 3′ overhang. Generally, siRNA molecules are completely complementary to one strand of a target DNA molecule, since even single base pair mismatches have been shown to reduce silencing. In other embodiments, siRNAs may have a modified backbone composition, such as, for example, 2′-deoxy- or 2′-O-methyl modifications.

In one embodiment, siRNA target sites are selected by scanning the target mRNA transcript sequence for the occurrence of AA dinucleotide sequences. Each AA dinucleotide sequence in combination with the 3′ adjacent approximately 19 nucleotides are potential siRNA target sites. In one embodiment, siRNA target sites are preferentially not located within the 5′ and 3′ untranslated regions (UTRs) or regions near the start codon (within approximately 75 bases), since proteins that bind regulatory regions may interfere with the binding of the siRNP endonuclease complex (Elshabir, S. et al. Nature 411:494-498 (2001); Elshabir, S. et al. EMBO J. 20:6877-6888 (2001)). In addition, potential target sites may be compared to an appropriate genome database, such as BLASTN 2.0.5, available on the NCBI server at www.ncbi.nlm, and potential target sequences with significant homology to other coding sequences eliminated.

Short hairpin RNAs may also be used to inhibit or knockdown gene or nucleic acid expression according to the invention. Short Hairpin RNA (shRNA) is a form of hairpin RNA capable of sequence-specifically reducing expression of a target gene. Short hairpin RNAs may offer an advantage over siRNAs in suppressing gene expression, as they are generally more stable and less susceptible to degradation in the cellular environment. It has been established that such short hairpin RNA-mediated gene silencing (also termed SHAGging) works in a variety of normal and cancer cell lines, and in mammalian cells, including mouse and human cells. Paddison, P. et al., Genes Dev. 16:948-58 (2002). Furthermore, transgenic cell lines bearing chromosomal genes that code for engineered shRNAs have been generated. These cells are able to constitutively synthesize shRNAs, thereby facilitating long-lasting or constitutive gene silencing that may be passed on to progeny cells. Paddison, P. et al., Proc. Natl. Acad. Sci. USA 99:1443-1448 (2002).

ShRNAs contain a stem loop structure. In certain embodiments, they contain variable stem lengths, typically from 19 to 29 nucleotides in length, or any number in between. In certain embodiments, loop size is between 4 to 23 nucleotides in length, although the loop size may be larger than 23 nucleotides without significantly affecting silencing activity. ShRNA molecules may contain mismatches, for example G-U mismatches between the two strands of the shRNA stem without decreasing potency. In fact, in certain embodiments, shRNAs are designed to include one or several G-U pairings in the hairpin stem to stabilize hairpins during propagation in bacteria, for example. However, complementarity between the portion of the stem that binds to the target mRNA (antisense strand) and the mRNA is typically required, and even a single base pair mismatch is this region may abolish silencing. 5′ and 3′ overhangs are not required, since they do not appear to be critical for shRNA function, although they may be present (Paddison et al. (2002) Genes & Dev. 16(8):948-58).

Chemical composition analysis essentially involves analyzing the chemical composition of the reagents selected according to the design method of the scientific method analysis described above. Generally, chemical composition analysis involves analyzing various characteristics of the reagents themselves, including interstructural properties, such as thermodynamic properties, base composition, predicted structural conformations, e.g., folding, ability to self-anneal, and related characteristics. Such characteristics may be determined under different conditions, e.g., pHs, in order to determine their appropriateness for a particular assay or use. In essence, this step involves examining the properties specific to the reagent itself, and their predicted effect on the reagent's effectiveness or potency.

The biological comparison process of the present invention is understood to involve comparing the reagents identified according to the scientific method analysis described above to one or more of an organism's biological properties, such as, e.g., genomic, enzymatic, or proteomic compositions. In particular embodiments, biological comparison comprises comparing the polynucleotide sequence of a selected reagent to the genomic sequence of a particular organism, in order to determined whether the reagent will have any undesired or non-specific effects on non-target genes, thus determining the specificity of the reagent for the target gene or polynucleotide sequence. In addition, this process may also comprise examining the secondary structure of the region of a target gene or mRNA that is targeted by a selected reagent, e.g., to determine whether secondary structure or bound histones or other polypeptides may interfere with the activity of the reagent.

Biological environment modeling generally involves factoring in information about the cellular (or non-cellular) environment in which the assay will be performed into reagent design. One or more cellular characteristics, such as cell mass, cytoplasmic or nucleolic properties, transcription and translation rates, types of proteins, electrical potential of the cell, membrane properties, internal and external pH, polynucleotide half-life and stability, and other pharmacokinetic properties, are used to model the predicted environmental effects on reagents.

Biological reaction analysis and assay categorization essentially comprises analyzing the output predicted from scientific method analysis, chemical composition analysis, biological comparison analysis, and/or biological environment modeling for various reagents and assays and sorting them according to their predicted effect. The results may include plotting of various reagents, assigning numerical scores or values to various reagents, based upon one or more predicted effects, and ranking of various reagents and assays based upon the desired effect or outcome. In addition, biological reaction analysis also includes designing appropriate assay controls (and related reagents) and methods of efficacy measurement. A variety of charts, graphs, graphical models, and other documents related to categorization of reagents and assays according to any of a variety of different factors, e.g., predicted potency and specificity, may be generated and stored.

Cataloging and document creation comprises sorting, serializing, and/or storing all output from various sources and analysis for documentation and retrieval. In certain embodiments, the output of the steps above are organized and rendered into a final document that is delivered to the user or customer, i.e., initiating party. This document may be in the form of a customized sales catalog, which includes various items, such as reagents and kits comprising the same for performing selected biological assays. The documents may further comprise predictions, prediction models, designs, serialized custom products, including kits, and/or protocols for performing one or more biological assays. Such documents may further comprise means to generate, retrieve, and/or purchase all items, supplemental items, or any sub-component of the output. Thus, in certain embodiments, the methods and systems of the present invention include organizing results of one or more of the analyses described above into groups and serializing and cataloguing these results for each customer or user.

The methods and systems of the present invention made be used to identify and/or categorize a wide variety of biological assays and reagents, including, e.g., PCR-based assays, such as real-time PCR and RT-PCR, as well as knockdown reagents such as antisense RNA and RNAi reagents. Furthermore, the methods and systems of the present invention may be used in a variety of applications, including diagnostic and therapeutic applications. As such, in certain embodiments, the present invention anticipates identifying/categorizing assays and reagents for any of these particular applications, as well as producing customized documents to assist in the selection of assays and reagents, as well as customized sales catalogs to assist in the selection and sale of reagents suitable for performing selected assays.

Products sold according to the business methods of the present invention include reagents for performing identified biological assays, as well as associated reagents, buffers, etc. For example, where a selected biological assay is an RNAi assay to knockdown expression of a target gene in a mammalian cell, then products might include various RNAi reagents, as well as buffers and other products to assist in transfecting the RNAi reagent into a cell. In addition, in certain embodiments, the catalog would further include negative control RNAi reagents, as well as RT-PCR reagents, e.g., oligonucleotides, and kits comprising the same, suitable for measuring the expression of the target gene, to determine whether the RNAI reagent was successful at reducing expression of the target gene.

In certain embodiments, products sold according to the invention include microarrays of different reagents, e.g., knockdown reagents targeting various genes or various regions of genes. For example, a microarray comprising knockdown reagents suitable to reduce expression of various genes expressed in a selected disease, e.g., a particular cancer, may be sold, wherein the specific knockdown reagents are selected or categorized according to methods or systems of the present invention. Such microarrays may be used, e.g., to test various reagents in order to determine the most therapeutically efficacious to treat a particular disease or patient.

In a related embodiment, kits or microarrays comprising oligonucleotides designed or selected according to methods and systems of the present invention to amplify or hybridize to polynucleotides containing specific mutations may be prepared and sold, e.g., as diagnostic tools suitable for identifying the particular mutation or molecular basis for a patient's disease. In certain embodiments, the methods and systems of the present invention are also used to design a therapeutic assay/treatment and select appropriate reagents, based upon the results obtained using this diagnostic kit or array.

It is understood that the methods and systems of the present invention may be practiced without the aid of computers or related software. However, in preferred embodiments, the methods and systems of the present invention are practiced using computers and software to accomplish one or more of the analyses described herein. Accordingly, the present invention may be embodied in many different forms, including, e.g., a method data processing system, or computer program product. Furthermore, the present invention may take the form of an entirely hardware embodiment, an entirely software embodiment, or an embodiment combining software and hardware aspects. Furthermore, the present invention may take the form of a computer program product on a computer-usable storage medium having computer readable program code means embodies in the medium. Any suitable computer readable medium may be utilized including, but not limited to, hard disks, CD-ROMs, optical storage devices, and magnetic storage devices.

One embodiment of the present invention is exemplified in FIG. 1 in a flowchart illustration of methods and analytical steps that may be performed by a computer. It is understood that each block of the flowchart illustration, and combinations of blocks in the flowchart illustration, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions or performing the analytical steps specified on the flowchart of FIG. 1.

In particular embodiments, the computer or other programmable data processing apparatus contain one or more knowledge bases that include information and/or rules useful in performing analyses. In preferred embodiments, the computer of other programmable data processing apparatus includes means for determining or obtaining a gene or polynucleotide sequence, based upon receiving information regarding said sequence in any of a variety of formats, including the entry of the sequence itself, the name of the gene and organism, or a sequence identifier number.

In one embodiment, a knowledge base includes a variety of different biological assays assigned for achieving different results, such as a group of assays suitable for determining levels of gene expression, a group of assays suitable for reducing gene expression, and/or a group of assays suitable for diagnosing a gene mutation. Such a knowledge base may further comprise expert rules for determining possible biological assays based upon patient or user input regarding the desired result.

In other embodiments, a knowledge base comprises expert rules for determining structural characteristics of a polynucleotide sequence, such as rules provided in the programs recited herein. In a related embodiment, a knowledge base comprises expert rules for comparing a polynucleotide sequence to another database, e.g., human genome database, to identify and/or predict biological interactions of a reagent in a cellular or genomic environment. Other knowledge bases may further comprise rules useful in determining the effects of various biological variables, such as, e.g., pH, temperature, cell type, transcription or translation rates, etc., on functional properties of reagents, including, e.g., hybridization and/or half-life.

In further embodiments, a knowledge base also includes rules for ranking of reagents and assays, based upon predicted biological outcomes determined from the sequence-based analyses performed using the expert rules. Reagent and assays may be ranked by one or more criteria, such as, but not limited to target specificity, cellular half-life, predicted potency or binding kinetics, and predicted efficacy.

Thus, in one embodiment, information regarding a target gene and desired result, e.g., reducing expression, is inputted into a computer comprising a knowledge base regarding biological assays, and the computer selects appropriate biological assays based upon the desired result. The computer then designs reagents suitable for use in said biological assay, based upon the sequence of the target genes, using expert rules for analyzing the chemical composition of potential reagents, as well as analyzing potential interactions in a biological system, such as a cell or genomic environment. The reagents are then ranked using several criteria, with related documentation produced. In addition, a customized catalog is generated, with products comprising one or more of the various reagents identified, as well as related reagents useful in performing the identified biological assays. Customers are supplied with the customized catalog and related documentation, and purchase desired products.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A method for producing a customized sales catalog of products, comprising:
(a) receiving information regarding a biological assay from a customer, wherein said information includes the identification of a target polynucleotide sequence and a desired result;
(b) designing one or more biological assays to achieve said desired result, wherein said designing includes identifying one or more reagents comprising a polynucleotide sequence that may be used is said biological assay; and
(c) generating a sales catalog comprising a reagent identified in step (b), thereby producing a customized sales catalog.

2. The method of claim 1, wherein a plurality of biological assays are designed according to step (b), further comprising: categorizing the biological assays designed in step (b) according to one or more predicted biological effects.

3. The method of claim 1, wherein said sales catalog further comprises protocols for performing the biological assays designed according to step (b).

4. The method of claim 1, wherein step (b) is performed using a computer device comprising:
a first knowledge base comprising a plurality of different biological assays; and
a second knowledge base comprising a plurality of rules for evaluating and selecting a biological assay based upon information received in step (a).

5. A business method for selling customized biological assay kits, comprising:
(a) receiving information regarding a biological assay from a customer, wherein said information includes the identification of a target polynucleotide sequence and a desired result;
(b) designing one or more biological assays to achieve said desired result, wherein said designing includes identifying one or more reagents comprising a polynucleotide sequence that may be used is said biological assay; and
(c) selling to the customer a kit comprising one or more of the reagents identified in step (b).

6. The business method of claim 5, further comprising generating a sales catalog comprising one or more kits comprising reagents identified in step (b), and providing said catalog to the customer.

7. The method of claim 5, wherein step (b) is performed using a computer device comprising:
a first knowledge base comprising a plurality of different biological assays; and
a second knowledge base comprising a plurality of rules for evaluating and selecting a biological assay based upon information received in step (a).

8. A method for guiding the selection of a therapeutic reagent for treating a disease or medical disorder, comprising:
(a) receiving information regarding a gene that is mutated or overexpressed in a disease or medical disorder;
(b) identifying one or more reagents comprising a polynucleotide sequence that may be used to reduce expression of the mutated or overexpressed gene of step (a);
(c) categorizing the reagents identified in step (b) based upon one or more predicted biological effects; and
(d) providing the categorization of step (c) to a medical professional, to assist in guiding the selection of a therapeutic reagent for treating the disease or medical disorder.

9. The method of claim 8, wherein said biological effects include binding specificity.

10. The method of claim 8, wherein step (b) and/or step (c) is performed using a computer device comprising:
a first knowledge base comprising a plurality of different biological assays and/or reagents; and
a second knowledge base comprising a plurality of rules for evaluating and selecting a biological assay and/or reagent based upon information received in step (a).

11. A business method for selling a therapeutic reagent to treat a disease or medical disorder associated with a gene mutation or gene overexpression, comprising:
(a) receiving information regarding a gene that is mutated or overexpressed in a disease or medical disorder;
(b) identifying one or more reagents comprising a polynucleotide sequence that may be used to reduce expression of the mutated or overexpressed gene of step (a); and
(c) selling a reagent identified in step (b) to a medical professional or patient for treatment of the disease or medical disorder.

12. The business method of claim 11, further comprising:
(d) categorizing the reagents identified in step (b) based upon one or more predicted biological effects; and
(e) providing the categorization of step (c) to a medical professional, to assist in guiding the selection of a therapeutic reagent for treating the disease or medical disorder.

13. The business method of claim 11 or claim 12, wherein step (b) and/or step (d) is performed using a computer device comprising:
a knowledge base comprising a plurality of different biological assays and/or reagents; and
a second knowledge base comprising a plurality of rules for evaluating and selecting a biological assay and/or reagent based upon information received in step (a).

14. A system for guiding the selection of a biological assay or reagent to achieve a desired result, comprising:
(a) a computing device comprising:
a first knowledge base comprising a plurality of different biological assays and/or reagents; and
a second knowledge base comprising a plurality of rules for evaluating and selecting a biological assay and/or reagent based upon the desired result;
(b) means for providing information regarding a target polynucleotide sequence and a desired result to said computing device; and
(c) means in said computing device for identifying and categorizing or ranking one or more biological assays and/or reagents comprising a polynucleotide sequence that may be used to reduce expression of said target polynucleotide sequence.

15. A computer program product for guiding the selection of a biological assay or reagent to achieve a desired result, said computer program product comprising a computer usable storage medium having computer readable program code means embodies in the medium, the computer readable program code means comprising:
(a) computer readable program code means for generating:
a first knowledge base comprising a plurality of different biological assays and/or reagents; and
a second knowledge base comprising a plurality of rules for evaluating and selecting a biological assay and/or reagent based upon the desired result;
(b) computer readable program code means for providing information regarding a target polynucleotide sequence and a desired result to said computing device; and
(c) computer readable program code means for identifying and categorizing or ranking one or more biological assays and/or reagents comprising a polynucleotide sequence that may be used to reduce expression of said target polynucleotide sequence.
